(19) United States
(12) Patent Application Publication
(10) Pub. No.: US 2012/0183234 A1
(43) Pub. Date: Jul. 19, 2012

(54) METHODS FOR PARALLELIZING FIXED-LENGTH BITSTREAM CODECS

(75) Inventors: Wei Liu, San Jose, CA (US); Mohammad Gharavi-Alkhansari, Santa Clara, CA (US)

(73) Assignee: SONY CORPORATION, Tokyo (JP)

(21) Appl. No.: 13/287,797

(22) Filed: Nov. 2, 2011

Related U.S. Application Data
(60) Provisional application No. 61/432,879, filed on Jan. 14, 2011.

(51) Int. Cl. G06T 9/00

(52) U.S. Cl. 382/233; 382/234

(57) ABSTRACT

Bi-directional bitstream ordering is able to be used for expedited processing. The first part of the bitstream is coded in a standard format, but the end of the bitstream is coded in reverse order. In encoding and decoding, parallel processing is able to be implemented to provide more efficient (parallel and hence faster) encoding and decoding where a bitstream is separated and processed in parallel.

### CROSS-REFERENCE TO RELATED APPLICATION(S)

This application claims priority under 35 U.S.C. §119(e) of the U.S. Provisional Patent Application Ser. No. 61/432,879, filed Jan. 14, 2011 and titled, “PROPOSAL FOR CHANGES IN PE-L2 AND PE-H2 CODECS FOR POTENTIALLY BETTER HARDWARE PARALLELIZATION.” The Provisional Patent Application, Ser. No. 61/432,879, filed Jan. 14, 2011 and titled, “PROPOSAL FOR CHANGES IN PE-L2 AND PE-H2 CODECS FOR POTENTIALLY BETTER HARDWARE PARALLELIZATION” is also hereby incorporated by reference in its entirety for all purposes.

### FIELD OF THE INVENTION

The present invention relates to the field of image processing. More specifically, the present invention relates to improved hardware parallelization.

### BACKGROUND OF THE INVENTION

When encoding an image or an image block, the pixels are typically processed in a raster scan order. Thus, the generated bitstream for an image or an image block is in the same order. Because of this form of encoding, encoding and decoding of the image occurs in a serial fashion. Therefore, a more efficient process of encoding and decoding is desired when the total number of bits generated for the image or image block is fixed (constant).

### SUMMARY OF THE INVENTION

Bi-directional bitstream ordering is able to be used for expedited processing. The first part of the bitstream is coded in a standard format, but the end of the bitstream is coded in reverse order. In encoding and decoding, parallel processing is able to be implemented to provide more efficient (parallel and hence faster) encoding and decoding where a bitstream is separated and processed in parallel.

In one aspect, a method implemented in a controller of a device comprises placing a first set of bits of a block in a bitstream starting at the beginning of the bitstream and placing a second set of bits in the bitstream starting at the end of the bitstream in a reverse order. The block is two lines and the first set of bits and the second set of bits are each approximately half of the bitstream. The block is more than two lines and the first set of bits are even lines and the second set of bits are odd lines of the block. The device is an encoder. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

In another aspect, a method of decoding a bitstream in a controller of a device comprises decoding a first set of bits of a block in the bitstream using a first processor and decoding a second set of bits in the bitstream using a second processor, wherein the second set of bits are in a reverse order. The block is two lines and the first set of bits and the second set of bits are each approximately half of the bitstream. The block is more than two lines and the first set of bits are even lines and the second set of bits are odd lines of the block. The controller comprises hardware logic gates. The controller comprises a memory and a processor. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

In another aspect, a device comprises an encoding module for placing a first set of bits of a block in a bitstream starting at the beginning of the bitstream, placing a second set of bits in the bitstream starting at the end of the bitstream in a reverse order and a decoding module for: decoding the first set of bits in the bitstream using a first processor and decoding the second set of bits in the bitstream using a second processor. The block is two lines and the first set of bits and the second set of bits are each approximately half of the bitstream. The block is more than two lines and the first set of bits are even lines and the second set of bits are odd lines of the block. The encoder module and the decoder module comprise hardware logic gates. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

In yet another aspect, a device comprises a memory for storing an application, the application for decoding a first set of bits in a bitstream using a first processor and decoding a second set of bits in the bitstream using a second processor, wherein the second set of bits in a reverse order and a processing component coupled to the memory, the processing component configured for processing the application. The block is two lines and the first set of bits and the second set of bits are each approximately half of the bitstream. The block is more than two lines and the first set of bits are even lines and the second set of bits are odd lines of the block.

In another aspect, an encoder comprises a bitstream size and reconstruction quality computation component for computing a bitstream size and a reconstruction quality using different values of a quantization number, a mode decision component for determining a best mode of the bitstream size and reconstruction quality and a differential pulse code modulation encoding component for decoding a block of data using the best mode, wherein a variable length generation and concatenation block utilizes parallel processing to process bits of the block. The block is two lines and a first set of bits and a second set of bits are each approximately half of the bitstream, wherein the second set of bits are in reverse order. The block is more than two lines and a first set of bits are even lines and a second set of bits are odd lines of the block, wherein the second set of bits are in reverse order.

### BRIEF DESCRIPTION OF THE DRAWINGS

FIG. 1 illustrates a diagram of the prediction dependency of the pixels in an 8×2 block in DPCM mode of the random access capability (RAC) codec.

FIG. 2 illustrates a diagram of a standard raster scan order of coding and decoding in DPCM mode.

FIG. 3 illustrates a diagram of bi-directional ordering according to some embodiments for 8×2 RAC codec.

FIG. 4 illustrates a diagram of bi-directional syntax according to some embodiments for 8×2 RAC codec.

FIG. 5 illustrates a diagram of decoding order of standard decoding versus parallel processing of a bi-directional syntax according to some embodiments for 8×2 RAC codec.

FIG. 6 illustrates a diagram of bi-directional ordering with a block height greater than two according to some embodiments for 8×2 RAC codec.

FIG. 7 illustrates a diagram of an encoder implementing bi-directional ordering according to some embodiments for 8×2 RAC codec. FIG. 8 illustrates a diagram of bi-directional syntax according to some embodiments for 16×1 fixed number of bits (FNB) codec.

FIG. 9A illustrates a flowchart of bi-directional ordering according to some embodiments.

FIG. 9B illustrates a flowchart of bi-directional decoding according to some embodiments.

FIG. 10 illustrates a block diagram of an exemplary computing device configured to implement bi-directional ordering according to some embodiments.

### DETAILED DESCRIPTION OF THE PREFERRED EMBODIMENT

A random access capability (RAC) codec is described in U.S. patent application Ser. No. 12/789,010, filed May 27, 2010, titled, “IMAGE COMPRESSION METHOD WITH RANDOM ACCESS CAPABILITY,” which is hereby incorporated by reference. A fixed number of bits (FNB) codec is described in U.S. patent application Ser. No. 13/035,060, filed Feb. 25, 2011, titled, “METHOD OF COMPRESSION OF DIGITAL IMAGES USING A FIXED NUMBER OF BITS PER BLOCK,” which is hereby incorporated by reference.

A modified RAC codec or a modified FNB codec and its bitstream syntax are able to have the bits reordered in the bitstream to enable parallel decoding of each block. Parallel decoding branches within each block are able to reduce decoder delay or decoder gate size. The changes will also reduce delay and gate size in the Variable Length Coding (VLC) concatenation part of the encoder.

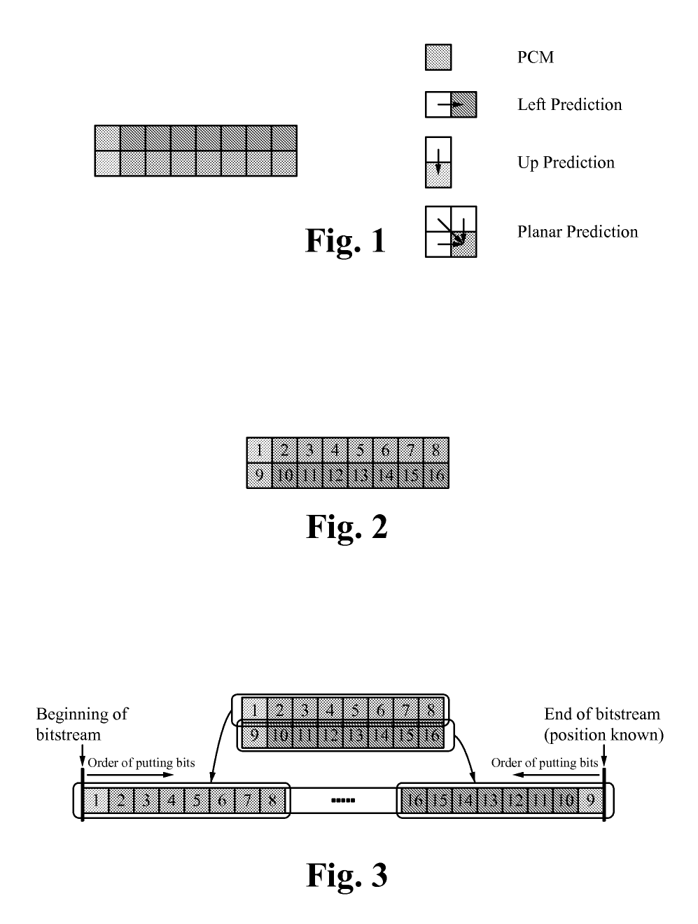

In the case of coding an 8×2 block in Differential Pulse Code Modulation (DPCM) mode in the RAC codec as shown in FIG. 1, the first sample is Pulse Code Modulation (PCM) coded. For the rest of the samples, the first row is predicted from the left, the first column is predicted from the top and the rest of the samples are predicted using planar prediction.

In The RAC codec, samples are coded and decoded in raster scan order as shown in FIG. 2. The VLC bits generated for the samples are also put in the bitstream in this order. Assuming that the decoding of each sample takes 1 clock cycle, the sample 1 is able to be decoded immediately, sample 2 takes 1 clock delay and sample 9 takes 8 clock delays. In terms of prediction, sample 9 is able to be decoded right after sample 1 is decoded. However, the decoder is not able to do this because the VLC bits of samples 2 to 8 are placed between those of samples 1 and 9. Similarly, for each of the samples 10 to 16, an extra delay of 7 clock cycles happens.

If the starting location of the VLC bits for the sample 9 were known in advance, then samples 2 and 9 are able to be decoded in parallel, followed by samples 3 and 10 in parallel, samples 4 and 11 in parallel and so on. Therefore, a bi-directional syntax includes placing the bits of samples 1 to 8 from the beginning of the fixed-length bitstream and placing the bits of samples 9 to 16 from the end of the fixed-length bitstream, in reverse order, as shown in FIG. 3.

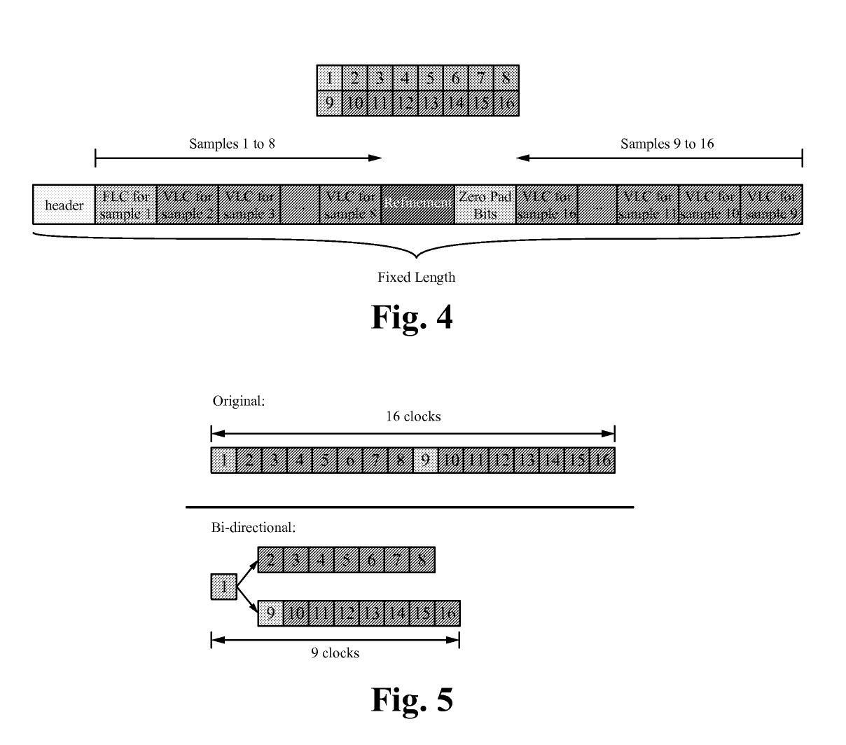

Using bi-directional syntax and decoding, there is no change to the samples in the first line (samples 1-8). However, samples (or pixels) in the second line are written from the last bit of the bitstream, in a reversed order. In The RAC codec, there is a fixed number of bits per block. With the bi-directional syntax, samples 2 and 9 are able to be decoded together, since there is no prediction dependency between them, and their VLC decoding is able to start together. Refinement bits and zero pads (if any) are placed in the middle of the bitstream as shown in FIG. 4.

The syntax takes 9 clock cycles to decode in the 8×2 block case as opposed to the original 16 clock cycles. The decoding order and its parallelization are shown in FIG. 5.

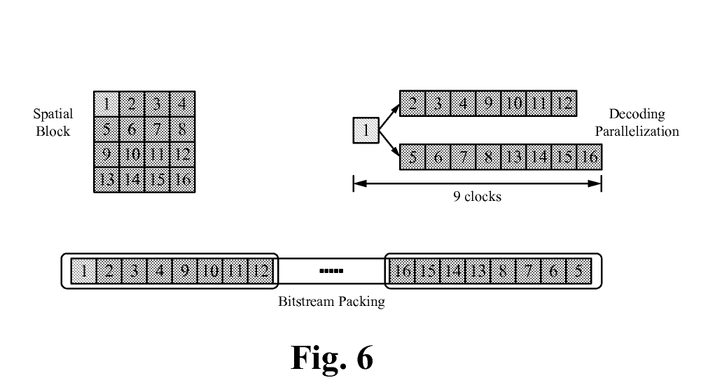

When a block has more than two lines, even lines are decoded in one decoding branch and odd lines are decoded in another branch as shown in FIG. 6. The corresponding bitstream ordering includes: even lines packed from left to right and odd lines packed from right to left, in reverse order. When there are an even number of lines, the decoding time is roughly reduced in half.

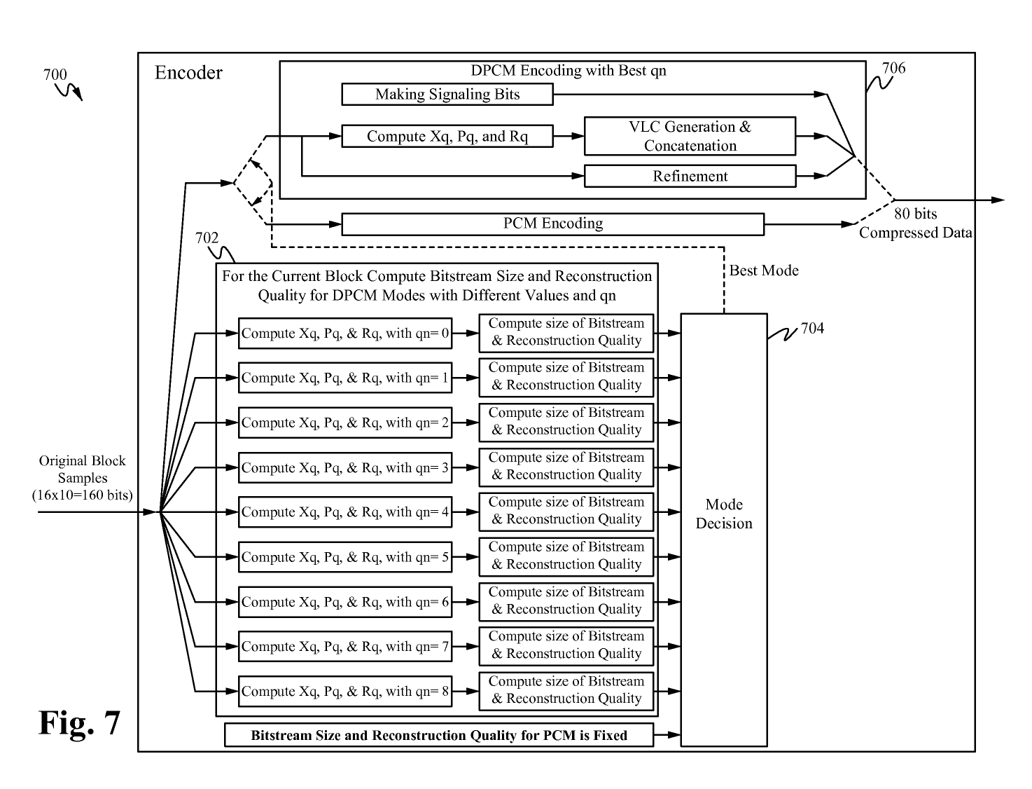

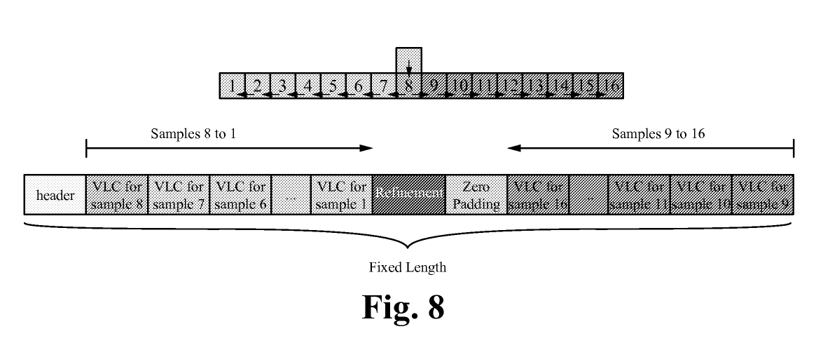

FIG. 7 shows a block diagram of a RAC encoder 700 according to some embodiments. The bitstream size and reconstruction quality are computed from different values of qn for the current block. Of the encodings based on differing values of a quantization number (qn), a best mode is selected. The data block is DPCM encoded using the best qn. In the DPCM encoding, the VLC concatenation part of the encoder in hardware is also able to benefit from a similar parallelization as described herein. The result is a compressed bitstream. In some embodiments, the encoder 700 includes one or more modules to perform bitstream size and reconstruction quality computation 702, mode decision 704 and DPCM encoding 706. The modules are able to be implemented in hardware, software, firmware or any combination thereof.

In the FNB codec, among all 9 modes, 8 modes do not have any prediction dependency among the pixels; therefore, bi-directional parallel decoding is able to be applied. Only the LEFT mode has a prediction dependency. With a standard prediction chain, at least 16 clocks are used: sample 1->sample 2->sample 3->. . . ->sample 16. A new LEFTRIGHT mode is able to replace LEFT, and the total delay is again reduced to 9. In some embodiments, since two VLC codewords are in the header, one of the codewords is able to be put at the tail of the bitstream. The new bitstream is shown in FIG. 8.

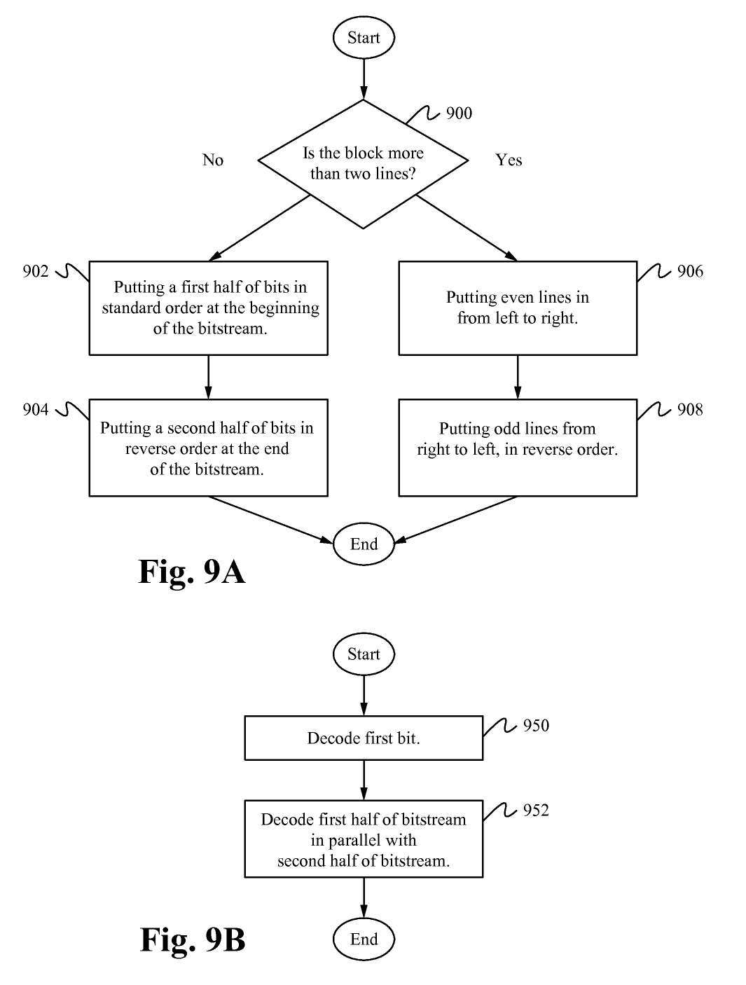

FIG. 9A illustrates a flowchart of a method of ordering a bitstream for bi-directional parallel decoding according to some embodiments. In the step 900, it is determined if the block has more than two lines. If the block does not have more than two lines, then a first half of the bits are placed in a standard order at the beginning of the bitstream, in the step 902. Then, in the step 904, a second half of the bits are placed in reverse order at the end of the bitstream. If the block does have more than two lines, even lines are placed in the bitstream from left to right, in the step 906. Then, in the step 908, the odd lines are placed from right to left and in reverse order. In some embodiments, fewer or additional steps are included. For example, in some embodiments, the steps ordering a bitstream of a block with more than two lines are separate from the steps with two lines, and there is no initial step of determining the number of lines of the block.

FIG. 9B illustrates a flowchart of bi-directional decoding according to some embodiments. In the step 950, the first bit is decoded. In the step 952, the first half of the bitstream is decoded in parallel with decoding the second half of the bitstream. In some embodiments, the first half of the bitstream is decoded on a first processor, and the second half of the bitstream is decoded on a second processor. When the block being decoded is more than two lines, the first half being decoded includes the even lines and the second half being decoded includes the odd lines of the block. When the block is not more than two lines, the first half being decoded is the first set of bits and the second half being decoded is the last bits of the block. The bitstream does not have to be divided exactly in half, variations are able to be implemented with the general idea of using parallel processing to make the decoding process more efficient. In some embodiments, fewer or additional steps are included.

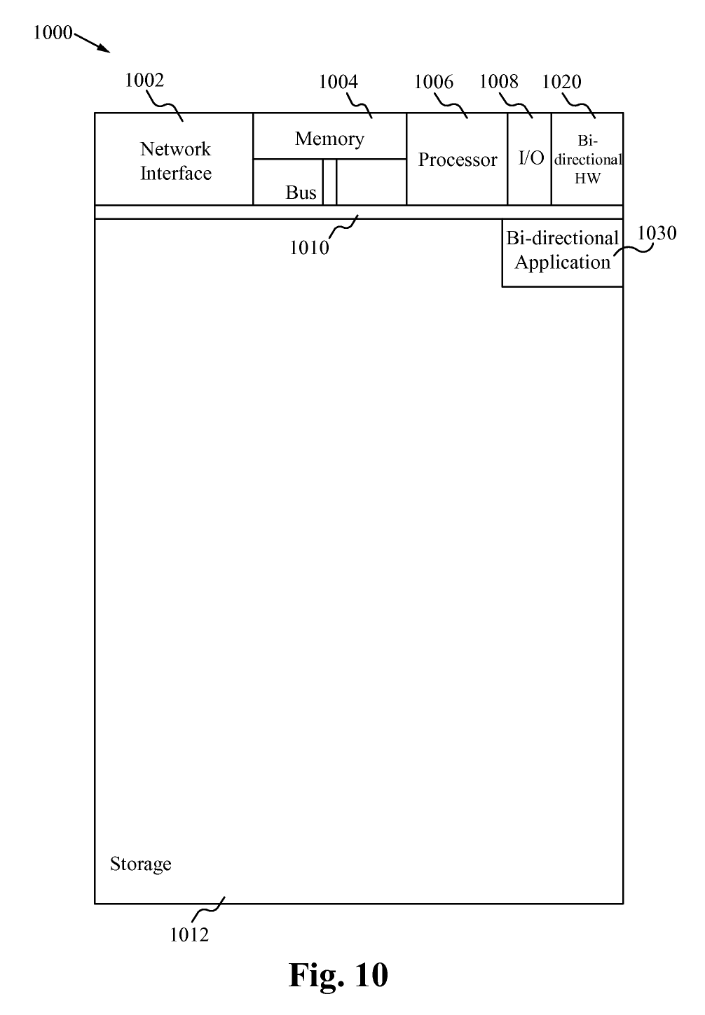

FIG. 10 illustrates a block diagram of an exemplary computing device 1000 configured to implement the bi-directional ordering according to some embodiments. The computing device 1000 is able to be used to acquire, store, compute, process, communicate and/or display information such as images, videos and audio. For example, a computing device 1000 is able to encode and/or decode data using the bi-directional syntax. The bi-directional syntax is typically used during or after acquiring images. In general, a hardware structure suitable for implementing the computing device 1000 includes a network interface 1002, a memory 1004, a processor 1006, I/O device(s) 1008, a bus 1010 and a storage device 1012. The choice of processor is not critical as long as a suitable processor with sufficient speed is chosen. The memory 1004 is able to be any conventional computer memory known in the art. The storage device 1012 is able to include a hard drive, CDROM, CDRW, DVD, DVDRW, flash memory card or any other storage device. The computing device 1000 is able to include one or more network interfaces 1002. An example of a network interface includes a network card connected to an Ethernet or other type of LAN. The I/O device(s) 1008 are able to include one or more of the following: keyboard, mouse, monitor, display, printer, modem, touchscreen, button interface and other devices. In some embodiments, the hardware structure includes multiple processors and other hardware to perform parallel processing. Bi-directional syntax application(s) 1030 used to enable the bi-directional parallel processing are likely to be stored in the storage device 1012 and memory 1004 and processed as applications are typically processed. More or less components shown in FIG. 10 are able to be included in the computing device 1000. In some embodiments, bi-directional syntax hardware 1020 is included. Although the computing device 1000 in FIG. 10 includes applications 1030 and hardware 1020 for implementing the bi-directional syntax, the bi-directional syntax method is able to be implemented on a computing device in hardware, firmware, software or any combination thereof. For example, in some embodiments, the bi-directional syntax applications 1030 are programmed in a memory and executed using a processor. In another example, in some embodiments, the bi-directional syntax hardware 1020 is programmed hardware logic including gates specifically designed to implement the method.

In some embodiments, the bi-directional syntax application(s) 1030 include several applications and/or modules. Modules include an encoding module for encoding a bitstream according to the syntax described herein and a decoding module for decoding the bitstream according to the syntax described herein. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television, a home entertainment system or any other suitable computing device.

To utilize the bi-directional bitstream ordering, a device encodes or decodes data such as an image or video using the specified order to enable expedited processing. In decoding, parallel processing is able to be implemented to provide more efficient decoding. The encoding and decoding utilizing the bi-directional bitstream is able to occur automatically without user intervention.

In operation, the bi-directional bitstream ordering speeds up the RAC and FNB decoding within a block. The technique is able to be applied to any codec where the block bit budget is fixed, and the number of bits is known in advance, before starting the encoding or decoding. The technique is demonstrated for the RAC codec and FNB coded herein. There is no performance loss compared to the RAC codec and FNB codec The method is able to be useful for encoding and decoding.

1. A method implemented in a controller of a device comprising:
a. placing a first set of bits of a block in a bitstream starting at the beginning of the bitstream; and
b. placing a second set of bits in the bitstream starting at the end of the bitstream in a reverse order.

2. The method of clause 1 wherein the block is two lines and the first set of bits and the second set of bits are each approximately half of the bitstream.

3. The method of clause 1 wherein the block is more than two lines and the first set of bits are even lines and the second set of bits are odd lines of the block.

4. The method of clause 1 wherein the device is an encoder.

5. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

6. A method of decoding a bitstream in a controller of a device comprising:
a. decoding a first set of bits of a block in the bitstream using a first processor; and
b. decoding a second set of bits in the bitstream using a second processor, wherein the second set of bits are in a reverse order.

7. The method of clause 6 wherein the block is two lines and the first set of bits and the second set of bits are each approximately half of the bitstream.

8. The method of clause 6 wherein the block is more than two lines and the first set of bits are even lines and the second set of bits are odd lines of the block.

9. The method of clause 6 wherein the controller comprises hardware logic gates.

10. The method of clause 6 wherein the controller comprises a memory and a processor.

11. The method of clause 6 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

12. A device comprising:
a. an encoding module for:
   i. placing a first set of bits of a block in a bitstream starting at the beginning of the bitstream;
   ii. placing a second set of bits in the bitstream starting at the end of the bitstream in a reverse order; and
b. a decoding module for:
   i. decoding the first set of bits in the bitstream using a first processor; and
   ii. decoding the second set of bits in the bitstream using a second processor.

13. The device of clause 12 wherein the block is two lines and the first set of bits and the second set of bits are each approximately half of the bitstream.

14. The device of clause 12 wherein the block is more than two lines and the first set of bits are even lines and the second set of bits are odd lines of the block.

15. The device of clause 12 wherein the encoder module and the decoder module comprise hardware logic gates.

16. The device of clause 12 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

17. A device comprising:
a. a memory for storing an application, the application for:
   i. decoding a first set of bits in a bitstream using a first processor; and
   ii. decoding a second set of bits in the bitstream using a second processor, wherein the second set of bits in a reverse order; and
b. a processing component coupled to the memory, the processing component configured for processing the application.

18. The device of clause 17 wherein the block is two lines and the first set of bits and the second set of bits are each approximately half of the bitstream.

19. The device of clause 17 wherein the block is more than two lines and the first set of bits are even lines and the second set of bits are odd lines of the block.

20. An encoder comprising:
a. a bitstream size and reconstruction quality computation component for computing a bitstream size and a reconstruction quality using different values of a quantization number;
b. a mode decision component for determining a best mode of the bitstream size and reconstruction quality; and
c. a differential pulse code modulation encoding component for decoding a block of data using the best mode, wherein a variable length generation and concatenation block utilizes parallel processing to process bits of the block.

21. The device of clause 20 wherein the block is two lines and a first set of bits and a second set of bits are each approximately half of the bitstream, wherein the second set of bits are in reverse order.

22. The device of clause 20 wherein the block is more than two lines and a first set of bits are even lines and a second set of bits are odd lines of the block, wherein the second set of bits are in reverse order.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method implemented in a controller of a device comprising:
a. placing a first set of bits of a block in a bitstream starting at the beginning of the bitstream; and
b. placing a second set of bits in the bitstream starting at the end of the bitstream in a reverse order.

2. The method of claim 1 wherein the block is two lines and the first set of bits and the second set of bits are each approximately half of the bitstream.

3. The method of claim 1 wherein the block is more than two lines and the first set of bits are even lines and the second set of bits are odd lines of the block.

4. The method of claim 1 wherein the device is an encoder.

5. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

6. A method of decoding a bitstream in a controller of a device comprising:
a. decoding a first set of bits of a block in the bitstream using a first processor; and
b. decoding a second set of bits in the bitstream using a second processor, wherein the second set of bits are in a reverse order.

7. The method of claim 6 wherein the block is two lines and the first set of bits and the second set of bits are each approximately half of the bitstream.

8. The method of claim 6 wherein the block is more than two lines and the first set of bits are even lines and the second set of bits are odd lines of the block.

9. The method of claim 6 wherein the controller comprises hardware logic gates.

10. The method of claim 6 wherein the controller comprises a memory and a processor.

11. The method of claim 6 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

12. A device comprising:
a. an encoding module for:
i. placing a first set of bits of a block in a bitstream starting at the beginning of the bitstream;
ii. placing a second set of bits in the bitstream starting at the end of the bitstream in a reverse order; and
b. a decoding module for:
i. decoding the first set of bits in the bitstream using a first processor; and
ii. decoding the second set of bits in the bitstream using a second processor.

13. The device of claim 12 wherein the block is two lines and the first set of bits and the second set of bits are each approximately half of the bitstream.

14. The device of claim 12 wherein the block is more than two lines and the first set of bits are even lines and the second set of bits are odd lines of the block.

15. The device of claim 12 wherein the encoder module and the decoder module comprise hardware logic gates.

16. The device of claim 12 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

17. A device comprising:
a. a memory for storing an application, the application for:
i. decoding a first set of bits in a bitstream using a first processor; and
ii. decoding a second set of bits in the bitstream using a second processor, wherein the second set of bits in a reverse order; and
b. a processing component coupled to the memory, the processing component configured for processing the application.

18. The device of claim 17 wherein the block is two lines and the first set of bits and the second set of bits are each approximately half of the bitstream.

19. The device of claim 17 wherein the block is more than two lines and the first set of bits are even lines and the second set of bits are odd lines of the block.

20. An encoder comprising:
a. a bitstream size and reconstruction quality computation component for computing a bitstream size and a reconstruction quality using different values of a quantization number;
b. a mode decision component for determining a best mode of the bitstream size and reconstruction quality; and
c. a differential pulse code modulation encoding component for decoding a block of data using the best mode, wherein a variable length generation and concatenation block utilizes parallel processing to process bits of the block.

21. The device of claim 20 wherein the block is two lines and a first set of bits and a second set of bits are each approximately half of the bitstream, wherein the second set of bits are in reverse order.

22. The device of claim 20 wherein the block is more than two lines and a first set of bits are even lines and a second set of bits are odd lines of the block, wherein the second set of bits are in reverse order.
